(19) United States
(12) Patent Application Publication
(10) Pub. No.: US 2025/0265385 A1
(43) Pub. Date: Aug. 21, 2025

(54) TEMPERATURE ESTIMATION MODEL AND METHOD FOR AN ELECTRICAL GENERATOR

(71) Applicant: Siemens Gamesa Renewable Energy A/S, Brande (DK)

(72) Inventors: Reza Nilifard, Herning (DK); Ziad Azar, Sheffield (GB); Dawei Liang, Sheffield (GB); Nima Madani, Vejle (DK); Ziqiang Zhu, Sheffield (GB)

(21) Appl. No.: 19/045,658

(22) Filed: Feb. 5, 2025

(30) Foreign Application Priority Data
Feb. 16, 2024 (EP) 24158017.4

(51) Int. Cl. G06F 30/20

(52) U.S. Cl. CPC G06F 30/20

(57) ABSTRACT

A method of temperature estimation of an electrical generator including plural generator components is provided including a rotor, and a stator having teeth and windings, the method including: using a thermal model for the generator including plural elementary thermal modeling elements partially connected to each other in a network for modeling heat conduction, wherein at least one elementary thermal modeling element includes: a first and a second error compensation thermal resistance (R_m1, R_m2) connected in series between a star point and a heat providing and/or absorbing system; the method including: estimating plural values of temperature for the plural elementary modeling elements by feeding plural values of the operational parameters into the thermal model and modeling heat transfers between and within the plural generator components or portions according to connectivities and thermal resistances within the network and within the elementary thermal modeling elements.

### CROSS-REFERENCE TO RELATED APPLICATIONS

This application claims priority to EP Application No. 24158017.4, having a filing date of Feb. 16, 2024, the entire contents of which are hereby incorporated by reference.

### FIELD OF TECHNOLOGY

The following relates to a method and to a corresponding arrangement of temperature estimation of a, in particular permanent magnet synchronous, electrical generator. Further, the following relates to a method and a corresponding controller for controlling an electrical generator, thereby applying the temperature estimation model and/or method. Furthermore, the following relates to a wind turbine.

### BACKGROUND

In direct-drive (DD) permanent magnet (PM) wind turbine generators, higher torque densities result in a higher wind turbine (WT) output power, but on the other hand, it may also result in higher operating temperatures due to losses and may limit the power capability due to irreversible PM demagnetization. In addition, the high generated temperature may have a significant effect on the machine lifetime, particularly for the most vulnerable generator components, e.g., stator winding insulation and PM. More specifically, the lifetime of the winding insulation is significantly affected by the temperature of stator winding. Therefore, the lifetime of winding insulation is of particular importance, which decreases significantly beyond the temperature specified by the manufacturers. Furthermore, irreversible partial demagnetization could be another issue when the PM temperature exceeds its maximum allowable temperature.

Consequently, higher winding and magnet temperatures reduce the generator component lifespan, which will result in lower generator efficiency, lower power density, and reliability. Therefore, their temperature information, especially the hotspot temperatures, is important to ensure safe and reliable operation under normal and overload conditions (e.g., power boost).

Although the winding and PM temperatures can be measured by thermal sensors, single or a few thermal sensors may inadequately measure the spatial temperature variations and hotspot temperature since the winding component usually has a large temperature gradient, which is sensitive to the location of the installed thermal sensor. Meanwhile, the installed thermal sensors also give rise to an increase in the cost, not only for themselves but also for the maintenance. Meanwhile, an array of thermal sensors increases the number of connection channels between the generator with the controller, which has a detrimental impact on the system reliability.

Up to date, the sensorless temperature estimation for generators relies on two mainstreams, i.e., the electrical parameter identification-based methods and thermal model-based methods.

Firstly, the electrical parameter identification-based methods utilize the temperature dependencies of the winding resistance (˜0.4%/° C.) and/or PM flux linkage (˜−0.1%/° C.) to estimate the overall average winding and PM temperatures. However, the electrical parameter identification methods suffer from several drawbacks. 1) Due to the rank-deficient issue, the identification methods usually require additional injected perturbation signals, e.g., currents and position offsets, which will introduce negative impacts on the system stability. 2) The reflected temperatures of the winding resistance and PM flux linkage are sensitive to measurement errors due to their low temperature coefficients, as well as manufacturing tolerances and imperfections. Meanwhile, they may still be much lower than the corresponding hotspot temperatures, although the hotspot temperature is more important.

Secondly, the thermal model-based methods are developed based on the heat transfer theorem to describe the thermal behavior of the system. However, due to inappropriate assumptions in the existing thermal model, i.e., either “I-type” or “T-type” networks, there may be significant deviations in both the average and hotspot temperature estimation. As a consequence, they may be not qualified to substitute to functions of thermal sensors due to low estimation accuracy, especially for the component having large temperature gradients, e.g., winding.

US2012226483 (A1) discloses a motor temperature estimation based on thermal model. A vehicle includes a power source, a motor, and a computing device. The power source provides electrical energy to the motor, and the motor generates rotational motion from the electrical energy received. The computing device is configured to estimate the temperature of the motor in real time based at least in part on a thermal model of the motor. The thermal model includes a plurality of nodes and at least one thermal resistance. Each node represents a region of the motor, and each thermal resistance represents a heat transfer path between at least two of the nodes. A method includes solving one or more energy balance equations to determine a temperature change at each node and estimating the temperature of the motor in real time based at least in part on the temperature change at each node and at least one of the thermal resistances in the thermal model.

US2019114385 (A1) discloses a motor thermoanalysis method with temperature field directly coupled with heat circuit. A motor thermal analysis method with a temperature field directly coupled with a thermal circuit is used for modeling partial parts of the motor, and a thermal circuit method is used for modeling other parts. A temperature field is contacted with a thermal circuit through an equivalent temperature boundary and an equivalent convection boundary. The thermal circuit part is composed of one-dimensional finite elements, and two connecting boundaries are deemed as two boundary elements. An element stiffness matrix, an element loading matrix and an element mass matrix corresponding to the one-dimensional finite elements and the boundary elements are respectively overlaid to a global stiffness matrix, a global loading matrix and a global mass matrix, and the distribution of temperature in the temperature field and the distribution of temperature in the thermal circuit are obtained simultaneously by solving a whole system of linear equations.

US2020341062 (A1) discloses a System and Method for Estimating Temperature and Heat Loss in Electric Motors. A system for thermal management of an electric motor, uses an augmented thermal circuit model of the electric motor, which relates temperatures of a set of nodes of the thermal circuit model with the temperature measurements at a first subset of nodes and heat losses of heat sources at a second subset of nodes, for joint estimation of the temperatures at the entire set of nodes and values of the heat losses in the second subset of nodes. The system solves the joint estimation using an estimator/observer. The system outputs one or combination of the values of the temperatures of the set of nodes and the values of the heat losses.

It has, however, been observed that the conventional methods for temperature estimation for generators do not in all circumstances or under all conditions give accurate estimations of temperature in particular for particular generator components having substantial temperature gradients.

Thus, there may be a need for a method and a corresponding arrangement of temperature estimation of a permanent magnet synchronous electrical generator, wherein temperature estimation may be improved and/or the accuracy may be enhanced, in particular for generator components or portions which may exhibit a substantial temperature gradient across their respective dimension or extent.

### SUMMARY

An aspect relates to a method of temperature estimation of an electrical generator including plural generator components comprising a rotor, and a stator having teeth and windings, the method comprising: receiving (e.g., measured) values of electrical and/or mechanical operation parameters of the generator; using a thermal model, in particular including or implemented in software, for the generator comprising plural elementary thermal modeling elements partially connected to each other in a network for modeling heat conduction, each generator component being modeled by one or more of the plural elementary thermal modeling elements wherein at least one elementary thermal modeling element comprises: for each of plural directions two conduction thermal resistances modeling thermal resistances between the respective portion of the generator component towards its boundary in opposite directions, a star point which is connected to (e.g., three) plural mid points between the respective two conduction thermal resistances; a heat providing and/or absorbing system modeling a heat source and/or heat sink; a first and a second error compensation thermal resistance connected in series between the star point and the heat providing and/or absorbing system; the method comprising: estimating plural values of temperature for the plural elementary modeling elements by feeding the plural values of the operational parameters into the thermal model and modeling heat transfers between and within the plural generator components or portions according to connectivities and thermal resistances within the network and within the elementary thermal modeling elements.

The generator may for example provide AC power in multiple phases, such as three phases or a higher number of phases. The rotor may be an outer rotor or an inner rotor.

The generator may be a permanent magnet synchronous electrical generator including a rotor with permanent magnets. In other embodiments the generator may be an electrically excited asynchronous electrical generator or doubly fed induction machine.

The permanent magnets may for example be mounted at an outer rotor house which may rotatably be supported by a bearing relative to the stator in order to allow rotation of the rotor with respect to the stator. The stator may be a single segment or a multiple segment stator. The stator may have one multi-phase winding set or multiple plural phase winding sets. Each winding set, for example three-phase winding set, may be connected to a respective converter, in particular comprising an AC/DC converter portion, a DC link and a DC/AC converter portion. Thereby, the converters may be configured to convert a variable frequency AC power stream to a fixed frequency AC power stream which may then be supplied to a utility grid.

The method may be implemented in software and/or hardware and may for example be performed by a generator controller or a processing portion separate from a generator controller.

The electrical and/or mechanical operation parameters of the generator may for example include current measurement values and/or a rotational speed of the generator and/or coolant and ambient temperatures. The operation parameters of the generator may for example be measured or may be estimated from other quantities relating to the performance or the operation of the generator.

The thermal model may in particular include or being implemented or represented in software and/or hardware, in particular including a software model.

The thermal model may for example be implemented in analogy to an electrical circuit including respective thermal resistances within the elementary thermal modeling elements which are partially connected to each other. Each elementary thermal modeling element by itself may be implemented in analogy to an electrical circuit having plural conduction thermal resistances and also having the first and the second error compensation thermal resistances, as specified.

The model may simulate a heat flow within and across the multiple generator components or generator component portions according to the spatial arrangement and connections between the plural elementary thermal modeling elements. Also within each of the elementary thermal modeling elements, the heat flow is modeled according to the respective (three times two) conduction thermal resistances and the first and the second error compensation thermal resistances.

For each generator component, for example the rotor house, the permanent magnets, the windings, the lamination of the stator or the stator teeth one or more elementary thermal modeling elements may be utilized, in order for example to model different spatial portions of the respective generator component. The number of the elementary thermal modeling elements for modeling one generator component or one generator component portion may be selected according to the desired accuracy of the temperature estimation and/or depending on the available computing resources.

The thermal model may in particular comprise plural thermal model segments, each segment corresponding to a respective axial region or axial position. Due to a substantial cylindrical symmetry of the generator, the thermal model segments may substantially be similar to each other. Thereby implementing the thermal modeling or setting up the thermal model may be simplified.

The conduction thermal resistances within a particular elementary thermal modeling element modeling a particular generator component or generator component portion may be based or may be derived from the geometry and/or material and/or extent of the respective generator component or generator component portion within the modeled spatial region. The same may hold for the first and the second error compensation thermal resistances.

It should also be understood that the respective conduction thermal resistances and/or the first and second error compensation thermal resistances may be determined based on calibration data including measured temperatures at the boundaries and/or the average temperature and/or a hotspot temperature of the respective generator component or generator component portion. Thus, the respective conduction thermal resistances and the first and second error compensation thermal resistances of each of the elementary thermal modeling elements may represent adjustable model parameters which may have previously been determined or calculated for example based on structure details, such as material, dimension and/or geometry and/or shape of the considered component and/or based on measurements of temperatures.

The provision of the first and second error compensation thermal resistances within at least one of the elementary thermal modeling elements (or all of the elementary thermal modeling elements) may enable to more accurately characterize or determine the temperature (distribution) within a generator component or a generator component portion. In embodiments, the first and the second error compensation thermal resistances may enable to accurately estimate average temperature and hotspot temperature (maximum temperature of the component or component portion being modeled by the considered elementary thermal modeling element), of respective generator component or generator component portion being modeled by the considered elementary thermal modeling element.

In conventional thermal models it may not have been possible to determine an average temperature as well as a hotspot temperature of a considered generator component or component portion. When both the average temperature as well as a maximum temperature of a particular generator component portion or generator component can be estimated, the generator may be controlled in an improved manner and may be diagnosed in an improved manner.

The heat providing and/or absorbing system may for example enable to model heat storage due to a particular heat storage capacity of the considered generator portion or generator component. Furthermore, thereby also heat generation may be modeled which may occur for example in a winding or winding coil. The heat providing and/or absorbing system may also thereby model loss input and thermal capacity of the different generator components or component portions.

According to an embodiment of the present invention, a temperature value estimated between the first and the second error compensation resistance is considered the mid-point temperature (e.g., theta_mid), which may be the maximum temperature (rise) caused by the internal loss generation.

The maximum temperature (rise) may be a space-related value and defined as the maximum temperature across the component. The mid-point temperature may be a temperature in the center/middle of the component or component portion being modeled.

Moreover, the other temperature value estimated between the second error compensation resistance and the heat providing and/or absorbing system is considered as an average temperature (e.g., spatially averaged across the component or component portion modeled by this elementary thermal modeling element) (e.g., theta_avg), of the respective component or portion.

Each of the elementary thermal modeling elements may be implemented or may comprise a circuitry of connected thermal resistances. In embodiments, two conduction thermal resistances may be connected in series, for each of the plural directions, for example for three directions. Midpoints of the serial connected three pairs of conduction thermal resistances may be connected to each other at the star point. To the star point also the series connection of the first and second error compensation thermal resistances are connected. Furthermore, the first error compensation thermal resistance, the second error compensation thermal resistance and the heat providing and/or absorbing system are connected in series to the star point. Thereby, the first and the second error compensation thermal resistances are connected to each other and the temperature as estimated between those two compensation thermal resistances is considered as a hotspot temperature of the respective generator component or generator component portion modeled by the considered elementary thermal modeling element.

When there is no internal heat generation, the temperature estimated at the star point can represent the spatial midpoint temperature physically. However, when the system has a heat providing system, it is assumed that all heat is concentrated in the spatial midpoint (spatial or geometrical center) instead of distributed throughout the whole solid in reality. Consequently, the estimated temperature at the star point is overestimated. Therefore, the first compensation thermal resistance is obtained based on the multi-dimensional conduction heat transfer equation to compensate for the temperature difference estimated from the star point to the real midpoint temperature.

Therefore, the temperatures estimated between those two compensation thermal resistances is the maximum temperature rise caused by the internal heat generation and can be regarded as the maximum temperature (of the component or component portion modeled) in most cases.

Thereby, a most critical region or a most critical temperature within the modeled generator portion may be identified.

According to an embodiment of the present invention, a temperature value determined between the second error compensation resistance and the heat providing and/or absorbing system is considered as an average temperature (e.g., theta_avg) of the respective component or component portion.

The second error compensation resistance is in the considered elementary thermal modeling element connected to the heat providing and/or absorbing system and the temperature determined between the second error compensation resistance and the heat providing and/or absorbing system considered as the average temperature of the respective component or component portion being modeled by the considered elementary thermal modeling element.

The second compensation thermal resistance is used to represent the temperature drops between the real midpoint temperature and the average temperature, which can be analytically determined by solving the multi-dimensional conduction heat transfer equation.

The average temperature of the respective component or component portion may, e.g., correspond to a spatially averaged (mean) temperature of the component or component portion. Thereby the overall or mean temperature of the modeled component may be obtainable, which may be useful to diagnose the condition of the respective component.

According to an embodiment of the present invention, both a maximum temperature as well as an average temperature of the respective component or component portion is estimated by the method.

Conventional thermal modeling methods may not have provided the maximum temperature as well as the average temperature of a respective component or component portion. When both these temperature values are available, diagnosing and/or controlling the generator may be improved and/or lifetime estimation may be provided.

According to an embodiment of the present invention, the first and/or the second error compensation resistance is calculated based on material and/or dimensions and/or volume and/or equivalent resistance accounting for parallel conduction and/or Eigenvalues in plural directions of the component or component portion, in particular as a sum, across plural (node) indices for three directions of plural products of sin functions.

The respective power compensation resistances may be derived from the characteristics of the respective modeled generator component or generator component portion.

According to an embodiment of the present invention, each generator component in each of plural spatial regions is modeled by one or more of the plural elementary thermal modeling elements, each one being associated with boundary temperature values for plural directions and bulk temperature values, the thermal connection of the plural generator components or component portions being modeled by heat transfer between boundaries of respective adjacent or neighboring elementary thermal network elements.

The elementary thermal modeling elements are connected to each other according to the spatial arrangement or positions of the respective modeled generator components or generator component portions.

The estimated temperatures at the respective ends of the series connected two conduction thermal resistances (for each of plural directions) may correspond to the temperatures at the boundaries of the respective modeled generator component in the respective direction.

Due to the low thermal conductivities of winding insulation and permanent magnet, the internal heat generation will cause the heat concentration within the solid, and the maximum temperature rise occurs in the spatial midpoint. Therefore, the estimated midpoint temperature is representative to indicate the hotspot temperature. In comparison, the scenario that the boundary temperature is the hotspot temperature rarely occurs when the permanent magnet machine is operating.

The hotspot temperature may correspond to the highest estimated temperature across the entire modeled generator component or generator component portion.

According to an embodiment of the present invention, estimating plural values of temperature comprises applying a heat transfer theorem or energy conservation theorem to the model, and/or wherein estimating plural values of temperature is performed sensorless without measuring any temperature of the generator except a cooling fluid temperature, and/or wherein estimating plural values of temperature is performed in real-time during operation of the generator; and/or estimating generator losses based on the estimated temperature values, and/or estimating wear and/or lifetime of a component or component portion based on the estimated temperature values, and/or diagnosing a fault of a component or component portion based on the estimated temperature values.

Thereby, the model may be implemented using one or more physical laws regarding heat transfer. Furthermore, the method may advantageously be utilized for downstream purposes such as controlling and/or diagnosing.

According to an embodiment of the present invention, wherein for each elementary thermal modeling element the following holds: two first serially connected conduction thermal resistances are provided for a first direction, two second serially connected conduction thermal resistances are provided for a second direction, two third serially connected conduction thermal resistances are provided for a third direction, wherein a point between the serially connected first two conduction thermal resistances is connected to the star point, wherein a point between the serially connected second two conduction thermal resistances is connected to the star point, wherein a point between the serially connected third two conduction thermal resistances is connected to the star point, wherein temperatures at two ends of the two first serially connected conduction thermal resistances are associated with the boundary temperatures of the respective elementary thermal modeling element according to the first direction, wherein temperatures at two ends of the two second serially connected conduction thermal resistances are associated with the boundary temperatures of the respective elementary thermal modeling element according to the second direction, wherein temperatures at two ends of the two third serially connected conduction thermal resistances are associated with the boundary temperatures of the respective elementary thermal modeling element according to the third direction.

The first direction may be a X-direction, the second direction may be a Y-direction, and the third direction may be a Z-direction corresponding to three orthogonal spatial directions. In other embodiments, for example cylindrical coordinates may be utilized. Thereby, conventionally available models may partially be utilized.

According to an embodiment of the present invention, the method further comprises, before using the thermal model: performing a model parameter calibration, including calibrating the thermal conductivities and thermal capacities for each of the elementary thermal modeling elements at least one of: the first, the second and/or the third two conduction thermal resistances, the first and/or the second error compensation thermal resistance, by comparing estimated temperature values with measures temperature values and/or minimizing an error function.

The parameter calibration may be needed to be performed only once. After the parameters have been determined or calibrated, the model may be utilized live (in real-time) without any adjustments of the respective model parameters. The temperature values may be measured at the different boundaries of each of the modeled generator component or generator component portions and may also be measured in the bulk region in order to determine the actual hotspot temperatures and also the average temperature. A least-square minimizing of the errors between the estimated temperatures and the measured temperature may be performed, for example according to the Gauss minimization of squares errors. Other calibration methods may be available or may be applied.

According to an embodiment of the present invention, it is provided a method for controlling a permanent magnet synchronous electrical generator including plural generator components comprising a rotor, permanent magnets and a stator having teeth and windings, the method comprising: performing a method of temperature estimation of the permanent magnet synchronous electrical generator according to one of the preceding embodiments; controlling a permanent magnet synchronous electrical generator based on the estimated plural values of temperature.

When accurate temperature values are estimated, the control of the generator may be improved. In embodiments, overheating may therefore be avoided by down-regulating one or more reference values when the determined hotspot temperatures and/or average temperature are above one or more temperature threshold(s). Thereby damage or ware of the generator may be reduced.

According to an embodiment of the present invention, the electrical and/or mechanical operation parameters of the generator include at least one of: currents; rotor speed; coolant temperature; ambient temperature.

According to other embodiments, the coolant temperature may not be utilized in operational parameters. Other operational parameters may be utilized, or less operational parameters may be utilized.

It should be understood that features, individually or in any combination, disclosed, described, explained or provided for a method of temperature estimation of a permanent magnet synchronous electrical generator may also be applied, individually or in any combination to an arrangement for temperature estimation of the generator according to embodiments of the present invention and vice versa.

According to an embodiment of the present invention, it is provided an arrangement for temperature estimation of a permanent magnet synchronous electrical generator including plural generator components comprising a rotor, permanent magnets and a stator having teeth and windings, the arrangement comprising: an input port adapted to receive values of electrical and/or mechanical operation parameters of the generator; an implementation of a thermal model for the generator comprising plural elementary thermal modeling elements partially connected to each other in a network for modeling heat conduction, each generator component being modeled by one or more of the plural elementary thermal modeling elements wherein at least one elementary thermal modeling element comprises: for each of plural directions two conduction thermal resistances modeling thermal resistances between the respective portion of the generator component towards its boundary in opposite directions, a star point which is connected to (e.g., three) plural mid points between the respective two conduction thermal resistances; a heat providing and/or absorbing system modeling a heat source and/or heat sink; a first and a second error compensation thermal resistance connected in series between the star point and the heat providing and/or absorbing system; the arrangement comprising: a processor having access to the implementation of a thermal model and being configured to estimating plural values of temperature for the plural elementary modeling elements by feeding the plural values of the operational parameters into the thermal model and modeling heat transfers between and within the plural generator components or portions according to connectivities and thermal resistances within the network and within the elementary thermal modeling elements.

The arrangement may be configured to perform a method of temperature estimation of the permanent magnet synchronous electrical generator and may be implemented in software and/or hardware.

The processor may comprise arithmetic/logical processing capability and may have access to software instructions or a software program comprising instructions in order or configured to implement or control or carry out the method of temperature estimation.

According to an embodiment of the present invention, it is provided a controller for controlling a permanent magnet synchronous electrical generator including plural generator components comprising a rotor, permanent magnets and a stator having teeth and windings, the controller comprising: an arrangement according to the preceding embodiment; a control portion adapted to control the generator based on the estimated temperature values.

According to an embodiment of the present invention, it is provided a wind turbine, comprising: a permanent magnet synchronous electrical generator including plural generator components comprising a rotor, permanent magnets and a stator having teeth and windings; a hub with plural rotor blades, the hub being coupled to the rotor; a controller according to the preceding embodiment.

### BRIEF DESCRIPTION

Some of the embodiments will be described in detail, with reference to the following figures, wherein like designations denote like members, wherein:

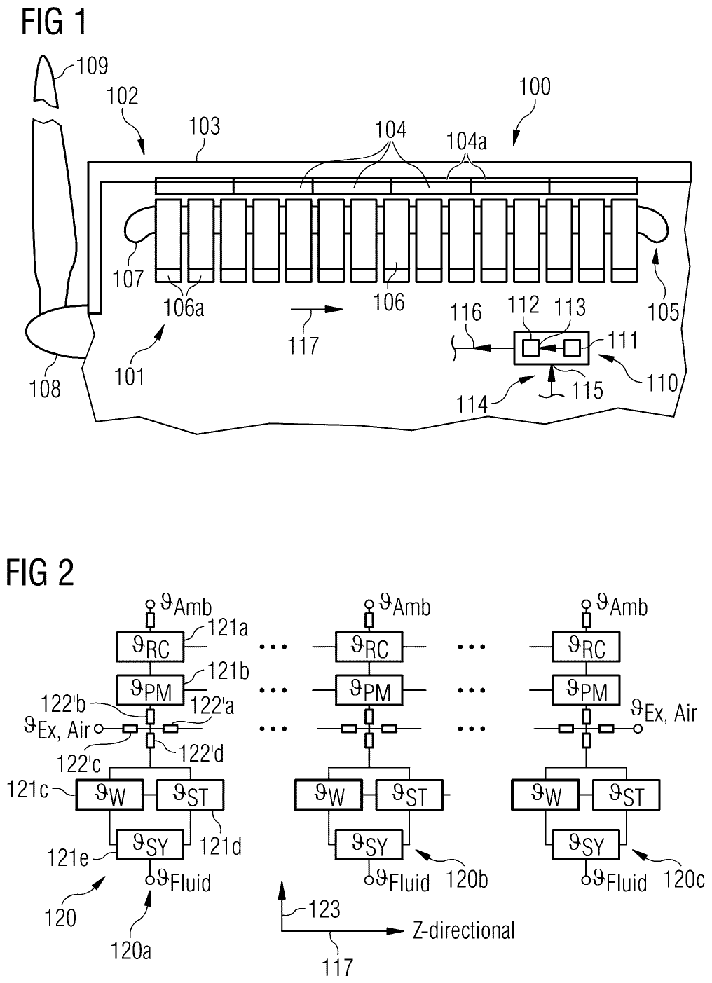

FIG. 1 schematically illustrates a wind turbine according to an embodiment of the present invention;

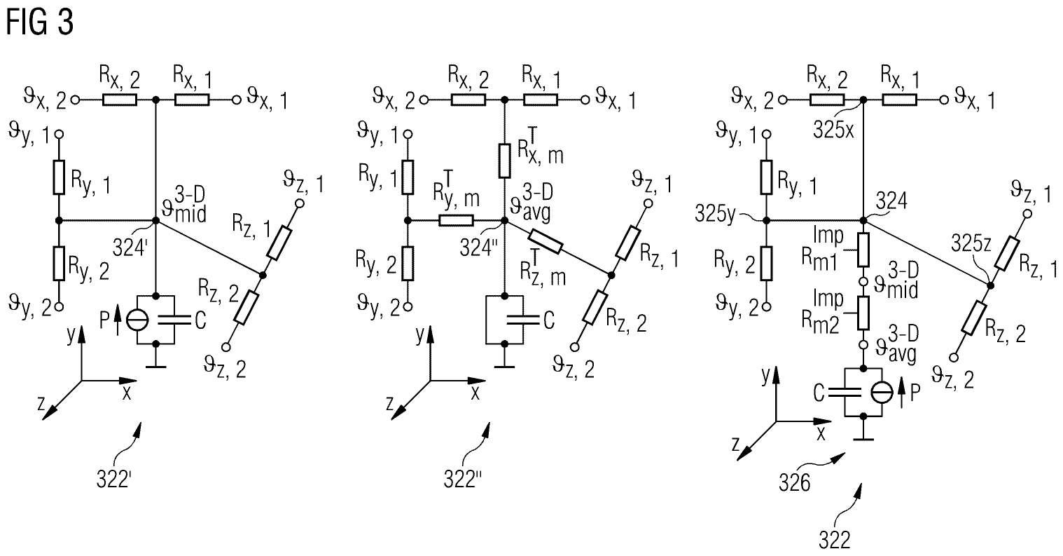

FIG. 2 schematically partially illustrates a thermal model as employed according to embodiments of the present invention;

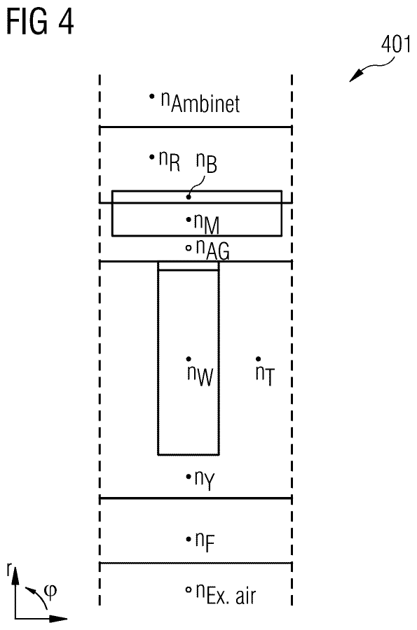

FIG. 3 schematically illustrates elementary thermal modeling elements as employed according to embodiments of the present invention;

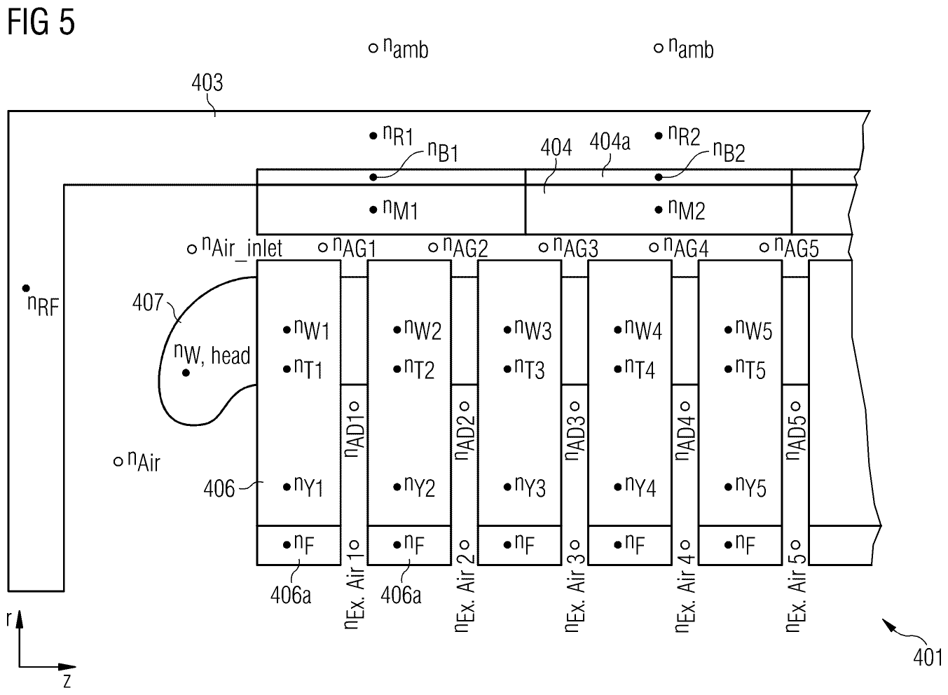

FIG. 4 schematically illustrates a portion of a generator in a cross-sectional view with network nodes of elementary thermally modeling elements for modeling a generator;

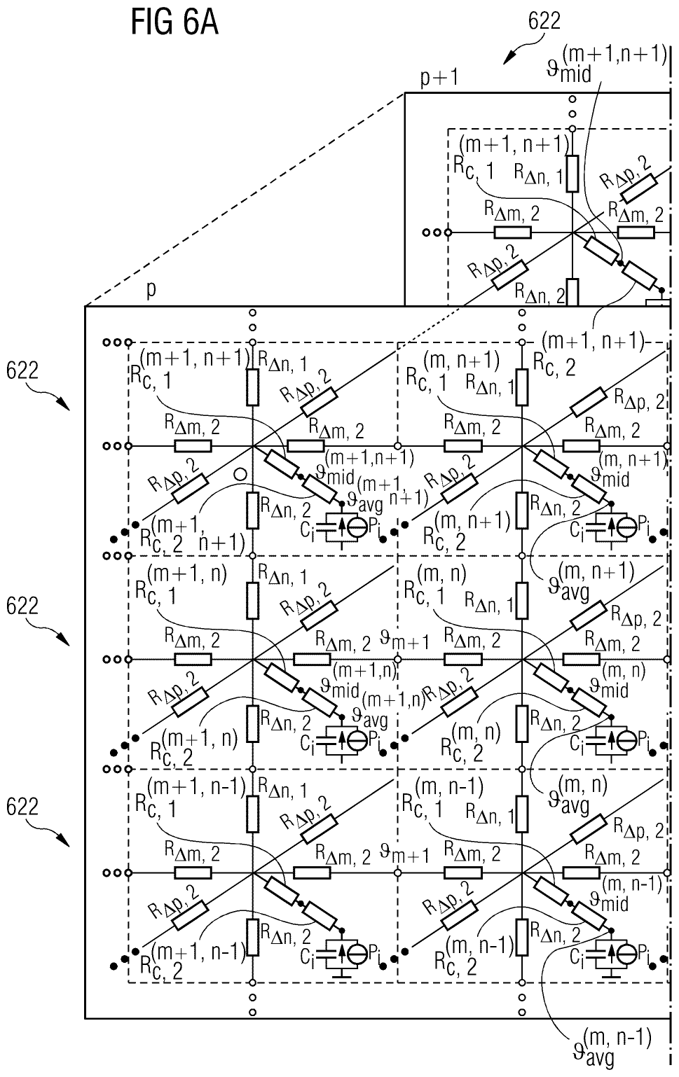

FIG. 5 schematically illustrates in a longitudinal sectional view thermal node configuration of the thermal model of FIG. 4 for modeling a permanent magnet generator;

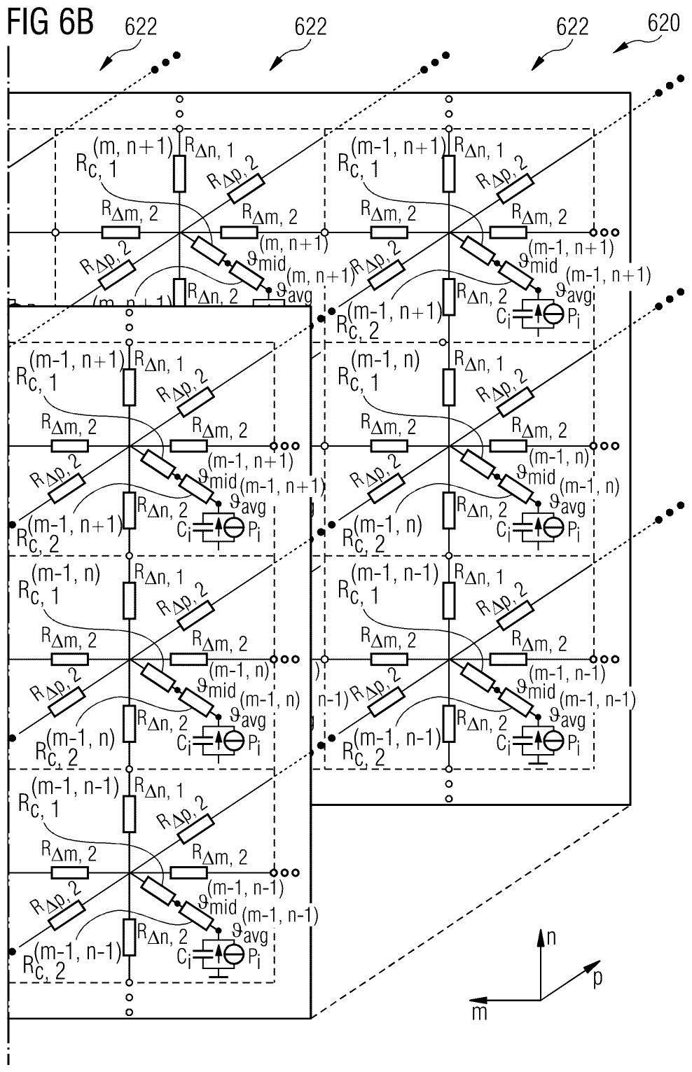

FIG. 6A schematically illustrates a portion of a thermal model implemented as a network of elementary thermal modeling elements as employed according to embodiments of the present invention;

FIG. 6B schematically illustrates a portion of a thermal model implemented as a network of elementary thermal modeling elements as employed according to embodiments of the present invention;

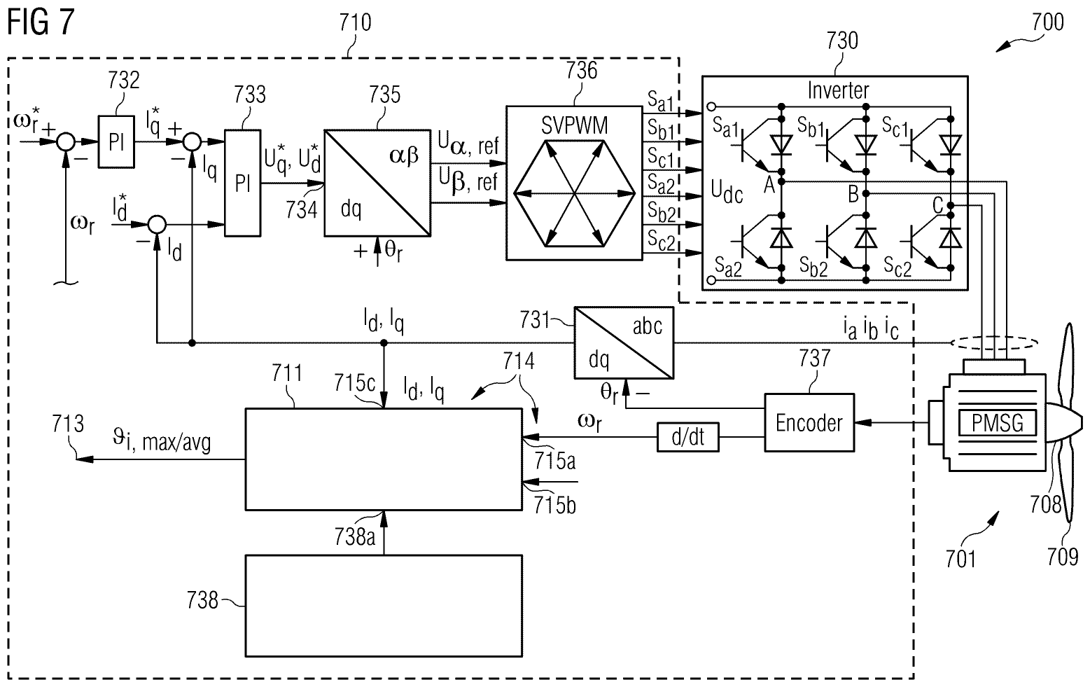

FIG. 7 schematically illustrates a wind turbine according to an embodiment of the present invention;

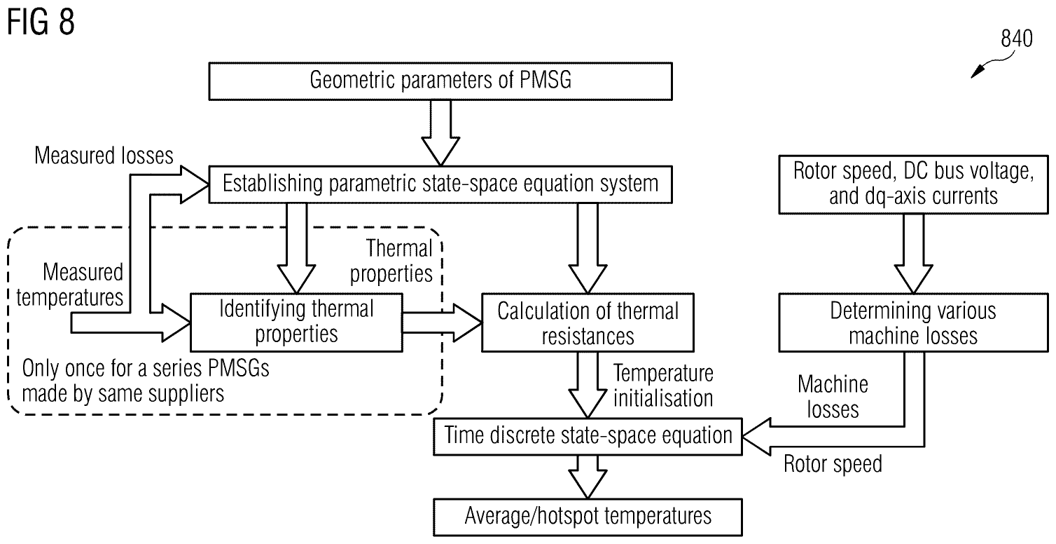

FIG. 8 schematically illustrates method schemes for setting up a thermal model and/or for calibration of model parameters; and

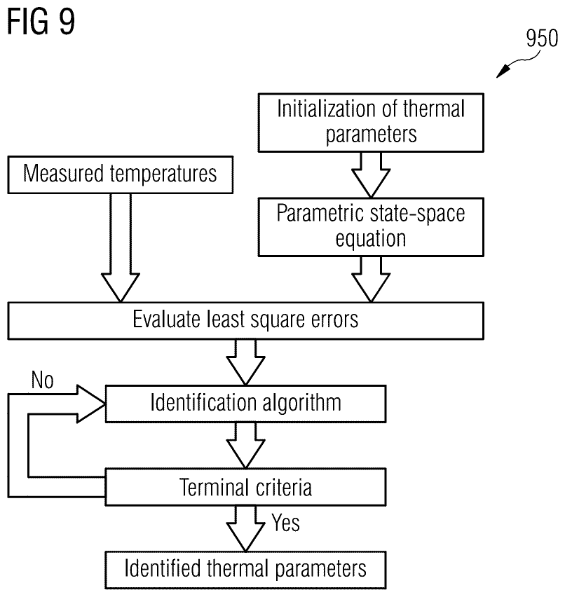

FIG. 9 schematically illustrates method schemes for setting up a thermal model and/or for calibration of model parameters.

### DETAILED DESCRIPTION

A description of an element not described in one embodiment may be taken from a description of this element with respect to another embodiment.

The wind turbine 100 schematically illustrated in FIG. 1 comprises a permanent magnet synchronous electrical generator 101 including plural generator components including a rotor 102 comprising a rotor house 103 and permanent magnets 104 (on base plates 104a) and a stator 105 having teeth 106 (on support or frame 106a) and windings 107. The generator 101 is an outer rotor generator. The rotor 102 is mechanically connected to a hub 108 at which plural rotor blades 109 are connected. The wind turbine 100 may be a direct drive wind turbine. Thus, the wind turbine 100 may be a gearless wind turbine, wherein the generator 101 is directly connected to the hub 108 without a gearbox in-between.

The wind turbine 100 further comprises a controller 110 for controlling the generator 101 according to an embodiment of the present invention. The controller 110 comprises an arrangement 111 for temperature estimation of the generator 101 according to an embodiment of the present invention. Further, controller 110 comprises a control portion 112 (e.g., including a processor) which is adapted to control the generator 101 based on estimated temperature values 113 which are estimated by the arrangement 111.

The arrangement 111 will be described in more detail with reference to FIG. 7 below. Briefly, the arrangement 111 receives at an input port 114 values 115 of plural electrical and/or mechanical operation parameters of the generator 101. The arrangement 111 further comprises an implementation of a thermal model for the generator 101. Thereby the arrangement 111 estimates the plural values 113 of the temperature of the different generator components based on the plural values 115 of the operational parameters.

The estimated temperature values 113 are then utilized by the control portion 112 in order to derive control signals 116 which are then utilized to control the generator 101, for example by supplying the control signals 116 to a converter which is connected to the generator 101.

FIG. 2 schematically illustrates a thermal model 120 as may be utilized by the arrangement 111 illustrated in FIG. 1. The Z-direction thereby corresponds to the axial direction 117 of the generator 101. The thermal model 120 illustrated in FIG. 2 comprises model portions or segments 120a, 120b, . . . which each model a particular axial region of the generator 101. Each model portion 120a,b, . . . comprises plural elementary thermal modeling elements 121a, 121b, 121c, 121d, 121e modeling different generator components or different generator component portions.

For example, the elementary thermal modeling element 121a models a particular axial region of the rotor 102, the element 121b models an axial region of the permanent magnets 104, the element 121c models an axial region of the stator winding 107, the element 121d models an axial region of the stator tooth 106 and the element 121e models an axial region of the stator yoke. According to other embodiments more or less elementary thermal modeling elements 121 may be provided or implemented. Between the rotor and the stator, the air gap is modeled by particular conductance resistances 122′a, 122′b, 122′c, 122′d modeling thermal conduction in the Z-direction (117) and also in the radial direction 123.

Embodiments of the present inventions provide a real-time temperature estimation method for the generator as illustrated in FIG. 1. According to the model 120, both the conductive and also the convection heat transfer are considered.

The elementary thermal modeling elements 121a, . . . 121e are collectively labeled with reference sign 121. At least one of the elementary thermal modeling elements illustrated in the model 120 of FIG. 2 is configured as the elementary thermal modeling element 322 illustrated in FIG. 3. Other elementary thermal modeling elements may be configured as one of the elementary thermal modeling elements 322′ or 322″ also illustrated in FIG. 3 or also as element 322.

The elementary thermal modeling element 322 schematically illustrated in FIG. 3 comprises for each of plural directions X, Y, Z two conduction thermal resistances (R_X,1, R_X,2 for the X-direction: R_Y,1, R_Y,2 for the Y-direction; R_Z,1, R_Z,2 for the Z-direction) modeling thermal resistances between the respective portion of the generator component towards its boundary in opposite directions (i.e., in the X-direction, Y-direction and Z-direction). The boundary temperature values are labeled for the X-direction with ∂_X,1 and 1_X,2 for the boundaries in the X-direction. Corresponding or analogous nomenclature is used for the Y-direction and Z-direction in FIG. 3.

The elementary thermal modeling element 322 further comprises a star point 324 which is connected to the three plural mid points 325x, 325y, 325z between the respective two conduction thermal resistances R_X,1, R_X,2, . . . . The elementary thermal modeling element 322 further comprises heat providing and/or absorbing system 326 which models a heat source and/or a heat sink. Furthermore, the elementary thermal modeling element 322 comprises a first and a second error compensation thermal resistance R_M1, R_M2, which are connected in series between the start point 324 and the heat providing and/or absorbing system 326.

The arrangement 111 illustrated within the controller 110 in FIG. 1 uses at least one elementary thermal modeling element as illustrated as the element 322 in FIG. 3 in the model 120 illustrated in FIG. 2 for modeling the generator 101 illustrated in FIG. 1. According to a particular embodiment of the present invention, each of the elementary thermal modeling elements 221a, 221b, 221c, 221d, 221e as illustrated for the model portion 120a and also for the other model portions 120b, . . . are implemented according to the element 322 illustrated in FIG. 3. In other embodiments, one or more elementary thermal modeling elements may be implemented according to the elements 322′, 322″ illustrated in FIG. 3.

All these elementary thermal modeling elements 322, 322′, 322″ comprise a respective star point 324, 324′, 324″ and they also comprise the respective two conduction thermal resistances for each of the plural directions. However, the elementary thermal modeling elements 322′, 322″ illustrated in FIG. 3 can only determine for example a hotspot temperature or an average temperature of a generator component but not both, a hotspot temperature and an average temperature.

The hotspot temperature which can be estimated with the elementary thermal modeling element 322 is labeled with reference ∂_MID and the average temperature is labeled with the reference sign ∂_avg. The element 322′ may conventionally also be referred to as I-type model and the element 322″ may be referred as a T-type elementary element. The conventional I-type and T-type elementary thermal elements are designed to estimate the mid-point and average temperatures, respectively. However, as aforementioned, their estimation accuracy cannot be guaranteed. With those conventional elements 322′, 322″ it is impossible to estimate the average and mid-point temperatures simultaneously.

In the proposed elementary thermal models, the conduction thermal resistances R_{Δi,1/2} are calculated by equation (1) below, which is the same as those in the “I-type” and “T-type” models.

$${R}_{Δ i , 1 / 2} = \frac{{l}_{i}}{2 {λ}_{i} A} \qquad ( 1 )$$

where lᵢ and A are the length of the heat flux path and the perpendicular area, respectively. λᵢ is the thermal conductivity in the i-direction, respectively.

For each component, the temperature rises caused by the difference in boundary temperatures and by the internal heat generation are subject to the principle of superposition. On the one hand, the temperature rise for each component caused by the difference in boundary temperatures can be calculated by the conduction thermal resistances (equation 1). On the other hand, the temperature rise caused by the internal heat generation needs to be calculated based on the multi-dimensional conduction heat transfer equation in (2) under zero boundary temperature conditions.

$${λ}_{x} \frac{{\partial }^{2} ϑ ( x , y , z )}{\partial {x}^{2}} + {λ}_{y} \frac{{\partial }^{2} ϑ ( x , y , z )}{\partial {y}^{2}} + {λ}_{z} \frac{{\partial }^{2} ϑ ( x , y , z )}{\partial {z}^{2}} + \dot{q} = 0 \qquad ( 2 )$$

where ∂ is the temperature distribution. ∇ is the Laplace operator. \dot{q} is the loss density. λₓ, λ_{y}, and λ_{z} are the thermal conductivities in the x-, y-, and z-directions.

By using the method of separation variables, the final solution of the temperature distribution can be written in (3)

$$ϑ ( x , y , z ) = {\sum }_{m , n , p = odd} {A}_{mnp} sin ( {α}_{m} x ) sin ( {β}_{n} y ) sin ( {γ}_{p} z ) \qquad 3 ( a )$$

$${A}_{mnp} = \frac{- 64 \dot{q}}{mnp {π}^{3} ( {λ}_{x} {α}_{m}^{2} + {λ}_{y} {β}_{n}^{2} + {λ}_{z} {γ}_{p}^{2} )} \qquad 3 ( b )$$

where αₘ, βₙ, and γₚ are the eigenvalues in the x-, y-, and z-directions, which are calculated by the zero boundary conditions in (4), and expressed in (5).

$$\begin{matrix}ϑ ( {W}_{s} , y , z ) = 0 \\ ϑ ( x , {H}_{s} , z ) = 0 \\ ϑ ( x , y , {L}_{s} ) = 0\end{matrix} \qquad ( 4 )$$

$${α}_{m} = \frac{m π}{{w}_{s}} , {β}_{n} = \frac{n π}{{h}_{s}} , {γ}_{p} = \frac{p π}{{l}_{s}} \qquad ( 5 )$$

where Wₛ, Hₛ, and Lₛ are the width, height, and the axial length for the component in the PMSG.

According to (3), the spatial midpoint temperature ∂_mid and the average temperature ∂_avg can be calculated by:

$$\{ \begin{matrix}{ϑ}_{mid} = {\sum }_{odd} {A}_{mnp} sin ( \frac{m π}{2} ) sin ( \frac{m π}{2} ) sin ( \frac{p π}{2} ) \\ {ϑ}_{avg} = {\sum }_{odd} - \frac{8 {A}_{mnp}}{mnp {π}^{3}}\end{matrix} \qquad ( 6 )$$

The temperature deviation from that estimated at the star point to the analytically calculated midpoint/average temperatures, i.e., ∂_mid/∂_avg, can be compensated by the two compensation thermal resistances R_{xyz,m1}^{Imp} and R_{xyz,m2}^{Imp}, as calculated by (7) and expressed in (8).

$$\{ \begin{matrix}{R}_{xyz , m 1}^{Imp} = \frac{{ϑ}_{mid}}{P} - {R}_{p} \\ {R}_{xyz , m 2}^{Imp} = \frac{{ϑ}_{avg}}{P} - \frac{{ϑ}_{mid}}{P}\end{matrix} \qquad ( 7 a )$$

$$\begin{matrix}{R}_{p , xyz} = 0.5 {R}_{x , 1} ‖ 0.5 {R}_{y , 1} ‖ 0.5 {R}_{z , 1} \\ = \frac{1}{4 {w}_{s} {h}_{s} {l}_{s} ( \frac{{λ}_{x}}{{w}_{s}^{2}} + \frac{{λ}_{y}}{{h}_{s}^{2}} + \frac{{λ}_{z}}{{l}_{s}^{2}} )}\end{matrix} \qquad ( 7 b )$$

$${R}_{xyz , m 1}^{Imp} = {\sum }_{odd} \frac{- 64 sin ( \frac{m π}{2} ) sin ( \frac{n π}{2} ) sin ( \frac{p π}{2} )}{mnp {π}^{3} ( {λ}_{x} {α}_{m}^{2} + {λ}_{y} {β}_{n}^{2} + {λ}_{z} {γ}_{p}^{2} ) V} - {R}_{p , xyz} \qquad ( 8 a )$$

$${R}_{xyz , m 2}^{Imp} = {\sum }_{odd} \frac{- 64 sin ( \frac{m π}{2} ) sin ( \frac{n π}{2} ) sin ( \frac{p π}{2} )}{mnp {π}^{3} ( {λ}_{x} {α}_{m}^{2} + {λ}_{y} {β}_{n}^{2} + {λ}_{z} {γ}_{p}^{2} ) V} - {\sum }_{odd} \frac{8}{mnp {π}^{3}} \frac{64}{mnp {π}^{3} ( {λ}_{x} {α}_{m}^{2} + {λ}_{y} {β}_{n}^{2} + {λ}_{z} {γ}_{p}^{2} ) V} \qquad ( 8 b )$$

where V is the volume of the component. R_{P,xyz} is the equivalent resistance accounting for parallel conduction thermal resistances in the x-, y- and z-directions.

FIGS. 4 and 5 illustrate the thermal node configuration of the modeled generator 401. The nodes carry indices indicating the modeled generator component or generator component portion. For example, the index “ambient” refers to the ambient environment, the index “R” refers to the rotor house, the index “M” refers to the permanent magnets, the index “AG” refers to the air gap, the index “W” refers to the winding, the indices “T” and “Y” refer to the stator yoke or teeth, the index “F” refers to the frame of the stator.

The node configuration illustrated in FIGS. 4 and 5 can be adapted according to the requirements and changed by the desire of the thermal designer. The node configuration may vary from a simple configuration with a small number of nodes to a complex configuration with more nodes. Each node may be implemented by one of the elementary thermal modeling elements 322′, 322″, 322 illustrated in FIG. 3.

FIG. 6 schematically illustrates a portion of a thermal model 620 as employed according to embodiments of the present invention. The thermal model 620 may be considered as a high-order discrete thermal model to predict the spatial temperature distribution. The topology in each discrete element 622 of the model 620 illustrated in FIG. 6 may be implemented as an elementary thermal modeling element 322′, 322″ or 322, wherein at least one of the elements 622 is configured as the exemplary thermal modeling element 322 illustrated in FIG. 3. Also, the thermal resistances are derived according to the equations (1) and (8), e.g., Although the complex thermal model may be a computationally time-consuming process, the higher resolution of the thermal network (higher number of nodes) may provide more detail about the temperature distribution in the main components of the generator.

A temperature value ∂_MID estimated between the first and second error compensation resistances R_M1, R_M2 is considered as a hotspot temperature of the modeled component. A temperature value estimated between the second error compensation resistance R_M2 and the heat providing and/or absorbing system 326 illustrated in FIG. 3 is considered as an average temperature ∂_avg of the modeled component.

The first and second error compensation resistances R_M1, R_M2 may be calculated based on the material and/or design and/or shape of the modeled component as is detailed according to equations (7) and (8). Equation (2) may be considered as theorems for heat transfer or energy conservation which may be employed according to embodiments of the present invention. The resistances R_x,1, R_x,2 may be considered as first serially connected conduction thermal resistances for a first direction, namely the X-direction. Analogous nomenclature may apply to the Y- and Z-directions.

FIG. 7 schematically illustrates a wind turbine 700 according to an embodiment of the present invention. The wind turbine comprises a permanent magnet synchronous electrical generator 701, wherein the rotor is connected to a hub 708 to which plural rotor blades 709 are mounted. In the illustrated embodiment, the generator 701 is connected to an inverter or converter 730 which is controlled by a controller 710.

The controller 710 comprises the arrangement 711 for temperature estimation of the generator 701. At an input port 714 the arrangement 701 receives values 715a, 715b, 715c for plural operational parameters of the generator, in the present case the rotational speed Ω_R, the coolant and ambient temperatures 715b. The arrangement 711 further receives the currents 715c in the d and q reference frame as electrical input parameter.

The arrangement 711 comprises a thermal model, such as thermal model illustrated in FIG. 2 or 6 for estimating the values 713 of the temperatures for plural generator components. The currents ia, ib, ic of the generator are measured and converted using a transformation module 731 into the rotating d-q frame.

The controller 710 further comprises PI control portions 732, 733, which receive respective error values of rotational speed or currents in order to provide current and/or voltage references 734 in the d-q frame which are then converted to the alpha-beta frame by conversion model 735. Voltage references are then supplied to a space vector pulse width modulation module 736 which thereupon calculates gate signals for plural controllable switches comprised within the inverter or converter 730 for controlling the generator 701. The rotational speed Ω_R is measured by an encoder 737.

The controller 710 may or may not comprise also an offline thermal properties calibration module 738 (providing parameters 738 to arrangement 711) which may be utilized for parameter calibration of the model 120 utilized by the arrangement 711. As can be appreciated from FIG. 7, the real-time temperature estimation system is integrated into the controller 710 of the generator 701. The dq-axis currents, rotor speed as well as the coolant and ambient temperatures are measured, and these quantities are input for the real-time temperature estimation system or arrangement 711. The real-time temperature estimation system consists of a high-fidelity thermal model, for calculation of main machine losses and offline thermal calibration.

The FIG. 8 schematically illustrates the complete temperature estimation flowchart 840. Firstly, according to the geometric parameters, the parametric thermal model, as shown in FIG. 2, is established, where the thermal properties, including thermal conductivities, thermal capacities, and contact thermal resistance, are calibrated. More specifically, by using the optimization algorithm, e.g., particle swarm optimization, genetic algorithm, and sequential quadratic programming, the thermal parameters are identified by minimizing the least square errors of the predicted and measured temperature in eq. (9). The measured temperature information can be obtained from the tests of prototypes. The implementation of the calibration of thermal properties is shown in FIG. 7. It is worth noting that the calibration process only needs once based on a prototype PMSG, and then they can be used for the different PMSGs made by the same suppliers.

$$J = {\sum }_{k} {( {ϑ}_{i , m} [ k ] - {ϑ}_{i , p} [ k ] )}^{2} \qquad ( 9 )$$

where k is the sampling index. ∂_{i,m} and ∂_{i,p} are the measured and predicted temperatures.

Secondly, the machine losses, including iron loss, PM loss, copper loss, and mechanical loss, are measured/calculated, which can be modeled as the function of rotor speed, dq-axis currents, and DC bus voltage.

Thirdly, since the thermal resistance can be calculated by eqs. (1)-(4) based on the geometric parameters and calibrated thermal properties, the complete thermal model can be described by the state-space equation:

$$\dot{ϑ} = A ( n ) ϑ + B ( n ) u ( {ϑ}_{ext} , n , I , {U}_{DC} ) \qquad ( 10 )$$

$$y = C ϑ + Du \qquad ( 11 )$$

where ∂ is the temperature vector. u it is the input vector, including the reference temperatures ∂ₑₓₜ, i.e., ambient and fluid, as well as the machine losses determined by the load conditions (n,1, U_{DC}). A and B are the system and input matrices constituted by the thermal resistances. C and D are the identity matrix and the zero matrix, respectively.

Fourthly, for real-time implementation, the state-space equation in (10) and (11) is solved by numerical technique, e.g., the fourth-order Runge-Kutta method, expressed as:

$$ϑ [ k + 1 ] = ϑ [ k ] + {t}_{a} {\sum }_{i = 1}^{4} {b}_{i} {s}_{i} \qquad ( 12 )$$

where bᵢ and sᵢ are the weighting factor and the slope within the step interval.

Finally, the temperature vector ∂ involves the information on the average and hotspot temperatures for all components, which will be updated in each sampling period for real-time implementation.

FIG. 9 illustrates in more detail the calibration methodology 950. Based on measured temperatures and estimated temperatures, model parameters may be adjusted.

Embodiments of the present invention may provide one or more of the following advantages:
The estimated temperature in the developed system includes both the average and hotspot temperatures with high estimation accuracy, which is more important than the average temperatures calculated based on the estimated stator winding resistance and PM flux linkage.
The developed temperature estimation system is a non-invasive method, i.e., the injection of additional perturbation signals is not required. Therefore, the temperature estimation will not bring any detrimental impact on the system's reliability and stability.
The estimation accuracy is robust against the measurement noises and feasible over the entire torque-speed range. However, some identification methods are inapplicable at low-speed range due to low signal-to-noise ratio.

Embodiments of the present invention may provide one or more of the following technical features:
Since the proposed method can be used for online hotspot/average temperature monitoring of PMSG, the number of installed thermal sensors can be minimized or even removed. Therefore, the cost of measurement devices and maintenance will be reduced, while less utilization of thermal sensors also improves the system stability.
In the proposed temperature estimation method, the node configuration can be adjusted according to the requirements, and thus, the spatial temperature distribution is predictable. Therefore, the influences of non-uniform loss generation, e.g., PM loss and AC copper loss, can be considered, which may have significant impacts on the maximum temperature rises of the winding and PM.
The thermal properties of the main components can be calibrated in a prior, and thus, the developed temperature estimation system can be applied to DD PMSG with different sizes, but additional parameter calibration is not necessary.
The proposed method can be implemented inside the embedded turbine control system to effectively control generator winding temperature and prevent any thermal overload, which can be considered for all SGRE direct drive generators.
The proposed method would have significant impacts on extending the turbine lifetime (e.g., insulation system) and preventing any thermal overloading conditions, thereby improving the operation reliability.
The calibration process only needs once for a series of DD PMSGs made by the same supplier, and thus, the proposed scalable temperature estimation system is time-efficient.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method of temperature estimation of an electrical generator including plural generator components comprising a rotor, and a stator having teeth and windings, the method comprising:
receiving values of electrical and/or mechanical operation parameters of the generator;
using a thermal model for the generator comprising plural elementary thermal modeling elements partially connected to each other in a network for modeling heat conduction,
each generator component being modeled by one or more of the plural elementary thermal modeling elements
wherein at least one elementary thermal modeling element comprises:
for each of plural directions two conduction thermal resistances (R_x,1; R_x,2; R_y,1; R_y,2; R_z,1; R_z,2) modeling thermal resistances between the respective portion of the generator component towards its boundary in opposite directions,
a star point which is connected to plural mid points between the respective two conduction thermal resistances;
a heat providing and/or absorbing system modeling a heat source and/or heat sink;
a first and a second error compensation thermal resistance (R_m1, R_m2) connected in series between the star point and the heat providing and/or absorbing system;
the method comprising:
estimating plural values of temperature for the plural elementary modeling elements by feeding the plural values of the operational parameters into the thermal model, including or implemented in software, and modeling heat transfers between and within the plural generator components or portions according to connectivities and thermal resistances within the network and within the elementary thermal modeling elements.

2. The method according to claim 1, wherein a temperature value estimated between the first and the second error compensation resistance (R_m1, R_m2) is considered as a hot spot temperature (theta_mid), maximal temperature, of the respective component or portion.

3. The method according to claim 1, wherein a temperature value determined between the second error compensation resistance (R_m2) and the heat providing and/or absorbing system is considered as an average temperature (theta_avg) of the respective component or component portion.

4. The method according to claim 1, wherein both a maximum temperature as well as an average temperature of the respective component or component portion is estimated by the method.

5. The method according to claim 1, wherein the first and/or the second error compensation resistance (R_m1, R_m2) is calculated based on material and/or dimensions and/or volume and/or equivalent resistance accounting for parallel conduction and/or Eigenvalues in plural directions of the component or component portion, as a sum, across plural (node) indices for three directions, of plural products of sin functions.

6. The method according to claim 1, wherein each generator component in each of plural spatial regions is modeled by one or more of the plural elementary thermal modeling elements, each one being associated with boundary temperature values for plural directions and bulk temperature values, the thermal connection of the plural generator components or component portions being modeled by heat transfer between boundaries of respective adjacent or neighboring elementary thermal network elements.

7. The method according to claim 1,
wherein estimating plural values of temperature comprises applying a heat transfer theorem or energy conservation theorem to the model, and/or
wherein estimating plural values of temperature is performed sensorless without measuring any temperature of the generator except a cooling fluid temperature, and/or
wherein estimating plural values of temperature is performed in real-time during operation of the generator; and/or
estimating generator losses based on the estimated temperature values, and/or
estimating wear and/or lifetime of a component or component portion based on the estimated temperature values, and/or
diagnosing a fault of a component or component portion based on the estimated temperature values.

8. The method according to claim 1, wherein for each elementary thermal modeling element the following holds:
two first (R_x,1; R_x,2) serially connected conduction thermal resistances are provided for a first direction (x),
two second (R_y,1; R_y,2) serially connected conduction thermal resistances are provided for a second direction (y),
two third (R_z,1; R_z,2) serially connected conduction thermal resistances are provided for a third direction (z),
wherein a first point between the serially connected first two conduction thermal resistances is connected to the star point,
wherein a second point between the serially connected second two conduction thermal resistances is connected to the star point,
wherein a third point between the serially connected third two conduction thermal resistances is connected to the star point,
wherein temperatures at two ends of the two first serially connected conduction thermal resistances are associated with the boundary temperatures of the respective elementary thermal modeling element according to the first direction,
wherein temperatures at two ends of the two second serially connected conduction thermal resistances are associated with the boundary temperatures of the respective elementary thermal modeling element according to the second direction,
wherein temperatures at two ends of the two third serially connected conduction thermal resistances are associated with the boundary temperatures of the respective elementary thermal modeling element according to the third direction.

9. The method according to claim 1, further comprising, before using the thermal model:
performing a model parameter calibration, including calibrating for each of the elementary thermal modeling elements at least one of:
the first, the second and/or the third two conduction thermal resistances (R_x,1; R_x,2; R_y,1; R_y,2; R_z,1; R_z,2),
the first and/or the second error compensation thermal resistance (R_m1, R_m2),
by comparing estimated temperature values with measures temperature values and/or minimizing an error function.

10. The method for controlling an electrical generator including plural generator components comprising a rotor, and a stator having teeth and windings, the method comprising:
performing a method of temperature estimation of the electrical generator according to claim 1;
controlling the electrical generator based on the estimated plural values of temperature.

11. The method according to claim 10, wherein the electrical and/or mechanical operation parameters of the generator included at least one of:
currents;
rotor speed;
coolant temperature;
ambient temperature.

12. An arrangement for temperature estimation of an electrical generator including plural generator components comprising a rotor, and a stator having teeth and windings, the arrangement comprising:
an input port adapted to receive values of electrical and/or mechanical operation parameters of the generator;
an implementation solution of a thermal model, including or implemented in software, for the generator comprising plural elementary thermal modeling elements partially connected to each other in a network for modeling heat conduction,
each generator component being modeled by one or more of the plural elementary thermal modeling elements
wherein at least one elementary thermal modeling element comprises:
for each of plural directions two conduction thermal resistances (R_x,1; R_x,2; R_y,1; R_y,2; R_z,1; R_z,2) modeling thermal resistances between the respective portion of the generator component towards its boundary in opposite directions,
a star point which is connected to plural mid points between the respective two conduction thermal resistances;
a heat providing and/or absorbing system modeling a heat source and/or heat sink;
a first and a second error compensation thermal resistance (R_m1, R_m2) connected in series between the star point and the heat providing and/or absorbing system;
the arrangement comprising:
a processor having access to the implementation of a thermal model and being configured to estimating plural values of temperature for the plural elementary modeling elements by feeding the plural values of the operational parameters into the thermal model and modeling heat transfers between and within the plural generator components or portions according to connectivities and thermal resistances within the network and within the elementary thermal modeling elements.

13. A controller for controlling an electrical generator including plural generator components comprising a rotor, and a stator having teeth and windings, the controller comprising:
an arrangement according to claim 12;
a control portion adapted to control the generator based on the estimated temperature values.

14. A wind turbine, comprising:
an electrical generator including plural generator components comprising at least a rotor, and a stator having teeth and windings;
a hub with plural rotor blades, the hub being coupled to the rotor;
a controller according to claim 13,
the generator comprising one of:
a permanent magnet synchronous electrical generator including a rotor with permanent magnets;
